(19) United States
(12) Patent Application Publication
(10) Pub. No.: US 2013/0325300 A1
(43) Pub. Date: Dec. 5, 2013

(54) Method for operating an internal combustion engine

(71) Applicants: Michael Walter, Kornwestheim (DE); Joachim Palmer, Korntal-Muenchingen (DE)

(72) Inventors: Michael Walter, Kornwestheim (DE); Joachim Palmer, Korntal-Muenchingen (DE)

(73) Assignee: Robert Bosch GMBH, Stuttgart (DE)

(21) Appl. No.: 13/994,997

(22) PCT Filed: Nov. 29, 2011
(86) PCT No.: PCT/EP11/71269

§ 371 Date: Aug. 27, 2013

(30) Foreign Application Priority Data
Dec. 15, 2010 (DE) 10 2010 063 097.7

(51) Int. Cl. F02D 41/26

(52) U.S. Cl. CPC F02D 41/26
USPC 701/104

(57) ABSTRACT

A method for operating an internal combustion engine, in particular of a motor vehicle, is described. The internal combustion engine includes an injector for metering fuel into a combustion chamber. According to the method, the injector is opened during a control period for metering a fuel quantity. A change in a rotary motion of the internal combustion engine, which results from the fuel quantity, is ascertained. A function is ascertained which links the control period to the change in the rotary motion. A minimum control period during which the injector does not open just yet is ascertained with the aid of the function. An operating point-dependent control period of the injector is ascertained as a function of the minimum control period.

### FIELD OF THE INVENTION

The present invention relates to a method for operating an internal combustion engine.

### BACKGROUND INFORMATION

Injection systems having injectors for injecting fuel are generally believed to be understood. It is also believed to be understood that, depending on the type of injector, the injection period changes for a certain control period according to a not exactly predeterminable service life drift.

It is believed that this change in the injection period results in disadvantages during the operation of the internal combustion engine. This means, in particular, that the pollutant emissions increase due to the imprecise injection period. To compensate for this change in the injection period, methods are known for the so-called zero quantity calibration. In the case of a zero quantity calibration, a control period is usually ascertained during which a defined rotary motion of the crankshaft occurs as a result of the fuel injected during the control period. The control period mentioned above is then used to compensate for the service life drift of every type of injector.

It is also believed to be understood that during a predefined control period of the injector, the drivetrain as well as the engaged gear, i.e., the transmission ratio of the drivetrain, has an influence on the rotary motion of the crankshaft. For each gear there usually exists a characteristic curve which links the control period to the rotary motion resulting from the control period. For this reason, it is necessary for each individual drivetrain to have appropriate data input into the control unit of the internal combustion engine in order to carry out a zero quantity calibration.

### SUMMARY OF THE INVENTION

The object underlying the present invention is achieved by a method according to the description herein. Advantageous refinements are specified in the further descriptions herein. Features which are important for the present invention are furthermore specified in the following description and in the drawings; the features may be important for the present invention both alone and in different combinations without explicit reference being made thereto again.

By ascertaining an operating point-dependent control period of the injector as a function of a minimum control period during which the injector does not open just yet, the service life drift of the injector is advantageously compensated for. The minimum control period, which links a control period of the injector to a change in a rotary motion of the internal combustion engine, is advantageously ascertained from a function, the change in the rotary motion resulting from the control period.

A drivetrain-dependent input of data into the control unit is advantageously eliminated with the aid of the claimed method. Accordingly, it is not necessary to carry out tests with all drivetrain variants, design changes with regard to the components of a drivetrain may be implemented within a shorter period of time, and therefore all expenditures are eliminated which are necessary for a drivetrain-dependent data input for a zero quantity calibration.

In one advantageous specific embodiment of the method, the change in the rotary motion of the internal combustion engine is ascertained with the aid of an amplitude of a rotational speed change rate. A raw amplitude may be multiplicatively linked to the square of an averaged rotational speed of the internal combustion engine to form a compensated amplitude. In this way, it is advantageously achieved that a rotational-speed dependency of the raw amplitude is reduced. By multiplying by the square of the averaged rotational speed, the behavior of a centrifugal mass is emulated, the vehicle drivetrain being emulated as the centrifugal mass in a rough approximation. A precompensation of the raw amplitude according to the compensated amplitude thus results.

In one advantageous specific embodiment, the operating point-dependent control period is ascertained by additively linking the minimum control period to a multiplicative linkage of a setpoint injection quantity and a gradient. The operating point-dependent control period therefore advantageously represents a zero-quantity calibrated control period. Advantageously, the ascertainment of the operating point-dependent control period is thus easily ascertained in a zero-quantity-calibrating manner.

In one advantageous specific embodiment of the method, the function may be ascertained from value pairs with the aid of linear regression, each of the value pairs including the control period and the amplitude ascertained during the control period. A linear correlation between the control period and the amplitude is advantageously used to ascertain the minimum control period. Furthermore, the method advantageously minimizes the squared error after the linear regression.

In one advantageous specific embodiment of the method, the control period of one of the value pairs is greater than a starting control period. By using only those value pairs which have a control period which is greater than the starting control period, it is advantageously achieved that only those value pairs are incorporated into the computation of the function which are in an almost linear range of the function to be ascertained.

In one advantageous refinement of the method, multiple values are ascertained for the amplitude, the control period increases starting from a minimum control period, and the amplitude exceeds the starting amplitude during the starting control period. The starting control period thus ascertained shows the start of a range in which value pairs may be ascertained, each of which has an amplitude which has been reliably influenced by the metered fuel quantity.

In one advantageous refinement of the method, the starting amplitude is ascertained as a multiple, in particular a quadruple, of the standard deviation, the standard deviation being ascertained from multiple values for the amplitude. In this way, a limiting value, i.e., the starting amplitude, is advantageously established, this limiting value advantageously being related to the background noise generated by the drivetrain.

In one advantageous refinement of the method, the injector is controlled to ascertain the multiple values of the amplitude for such a short test control period that the injector reliably does not open. In this way, it is advantageously possible to ascertain a background noise or a corresponding performance figure with regard to the multiple values of the amplitude.

In one advantageous refinement of the method, the multiple values of the amplitude are ascertained in coasting mode. When ascertaining the multiple values in coasting mode, only the background noise of the drivetrain is advantageously ascertained, since injections reliably do not take place.

In one advantageous specific embodiment of the method, a defined number of value pairs is ascertained in each case for the ascertainment of the function in a state of the internal combustion engine in which a fixed transmission ratio of the power train is established. Since different functions would form for different gears or transmission ratios, it is prevented in this way that an incorrect minimum control period is ascertained.

In one advantageous specific embodiment of the method, the value pairs are ascertained for the ascertainment of the function in a state of the internal combustion engine in which the internal combustion engine is operated in a certain range of the rotational speed. In this way, it may be prevented that value pairs, which may occur in a disadvantageous range of the rotational speed, are incorporated in the computation of the minimum control period.

Additional features, possible applications, and advantages of the present invention are derived from the following description of exemplary embodiments of the present invention, which are illustrated in the figures of the drawing. All features described or illustrated represent the object of the present invention alone or in any arbitrary combination, regardless of their recapitulation in the patent claims or their back-references, and regardless of their wording in the description or illustration in the drawing. The same reference numerals are used for functionally equivalent variables in all figures, even in different specific embodiments.

Exemplary specific embodiments of the present invention are explained below with reference to the drawings.

### BRIEF DESCRIPTION OF THE DRAWINGS

FIG. 1 schematically shows a gasoline internal combustion engine having a direct injection by an injector.

FIG. 2 shows a schematic block diagram for ascertaining an operating point-dependent control period of the injector.

FIG. 3 shows a schematic diagram of a time and rotational speed change rate.

FIG. 4 shows a detailed schematic block diagram for ascertaining the operating point-dependent control period of the injector.

FIG. 5 shows a schematic diagram of control periods and amplitudes for ascertaining a minimum control period of the injector.

FIG. 6 shows a schematic block diagram for ascertaining the minimum control period of the injector.

### DETAILED DESCRIPTION

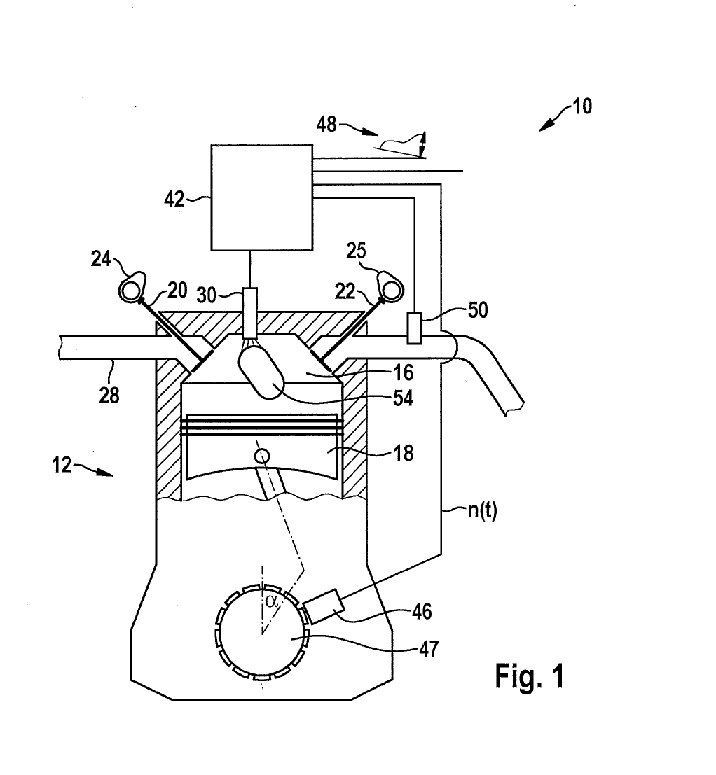

In FIG. 1, reference numeral 10 denotes the overall view of a diesel internal combustion engine 12 having an exhaust gas system 14. Internal combustion engine 12 has a combustion chamber 16 which is movably sealed by a piston 18. An inlet valve 20 is actuated by an inlet valve actuator 24 and an outlet valve 22 is actuated by an outlet valve actuator 25. Both inlet valve actuator 24 and outlet valve actuator 25 may be implemented by camshafts as mechanical actuators or by electrical, electrohydraulic, or electropneumatic actuators.

If inlet valve 20 is open, piston 18 takes in air from an intake manifold 28. Subsequently, the fuel is metered directly into combustion chamber 16 via an injector 30. The fuel auto-ignites when compressed. If outlet valve 22 is open, the combusted residual gases are expelled from combustion chamber 16 into exhaust gas system 14.

The control of internal combustion engine 12 takes place via a control unit 42 which, for example, processes signals of a rotational speed sensor 46, which cooperates with a sensor wheel 47, and of a driver input sensor 48. Rotational speed sensor 46 ascertains an angular position α, which is transmitted to control unit 42. Moreover, the signals of exhaust gas sensor 50 and the signals of other, not illustrated, sensors regarding pressures and/or temperatures in the area of internal combustion engine 12 or of exhaust gas system 14 may be supplied to control unit 42. With the aid of these and, if necessary, other input signals, control unit 42 forms control signals using which internal combustion engine 12 may be operated according to the driver input and/or according to preprogrammed requirements. In FIG. 1, a zone 54 containing a fuel/air mixture is generated by injecting a fuel quantity via injector 30. This zone 54 is surrounded by air within combustion chamber 16 and auto-ignites when compressed.

The method described in the following is not limited to diesel internal combustion engines, but may also be used with gasoline internal combustion engines having an intake manifold injection or a direct injection, a spark plug being assigned to the combustion chamber in this case. Injector 30 may in this case be configured as a magnetic injector or as a piezoelectric injector, for example.

To control injector 30, control unit 42 applies a digital signal, which determines the time period of the control of the injector, to an output stage component (not shown). According to the digital signal, the output stage component generates a control variable, the control variable being a voltage U or a current I. With the aid of the control variable, an actuator of injector 30 is controlled by the output stage component for the generation of a fuel injection. The behavior of the injector is reflected in the control variable and the opening point in time and the closing point in time of injector 30 may be determined, for example. The control variable is measured by control unit 42. A control period AD (not shown in FIG. 1) of injector 30 may, for example, be ascertained from the control variable and/or the digital signal. A rotational speed signal n(t) is ascertained by rotational speed sensor 46 and supplied to control unit 42.

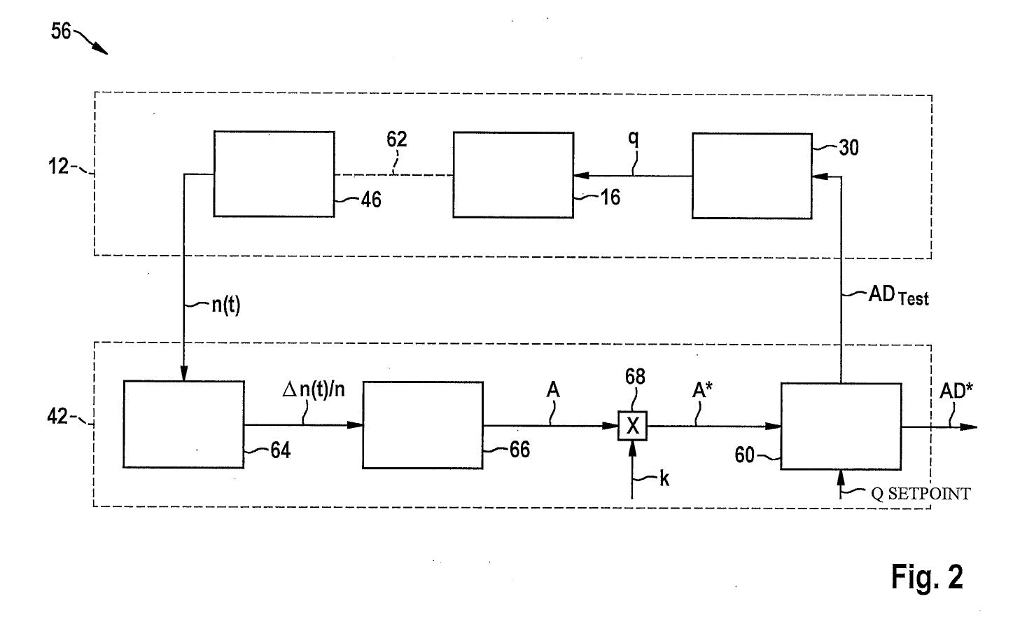

A subarea of internal combustion engine 12 and a subarea of control unit 42 are shown in FIG. 2. A block 60 generates a test control period ADtest which is supplied to injector 30. An injection quantity q is metered into combustion chamber 16 according to test control period ADtest. Metered fuel quantity q auto-ignites and generates a torque on a crankshaft and sensor wheel 47 which is connected to the crankshaft. Combustion chamber 16 is accordingly in operative connection 62 with rotational speed sensor 46.

Rotational speed signal n(t) which is ascertained by rotational speed sensor 46 is supplied to a block 64 of control unit 42. Alternatively to rotational speed signal n(t), a segment time signal, which indicates the time between the segments of sensor wheel 47, may also be supplied to block 64. The value of rotational speed signal n(t) is in this case reciprocal to the value of the segment time.

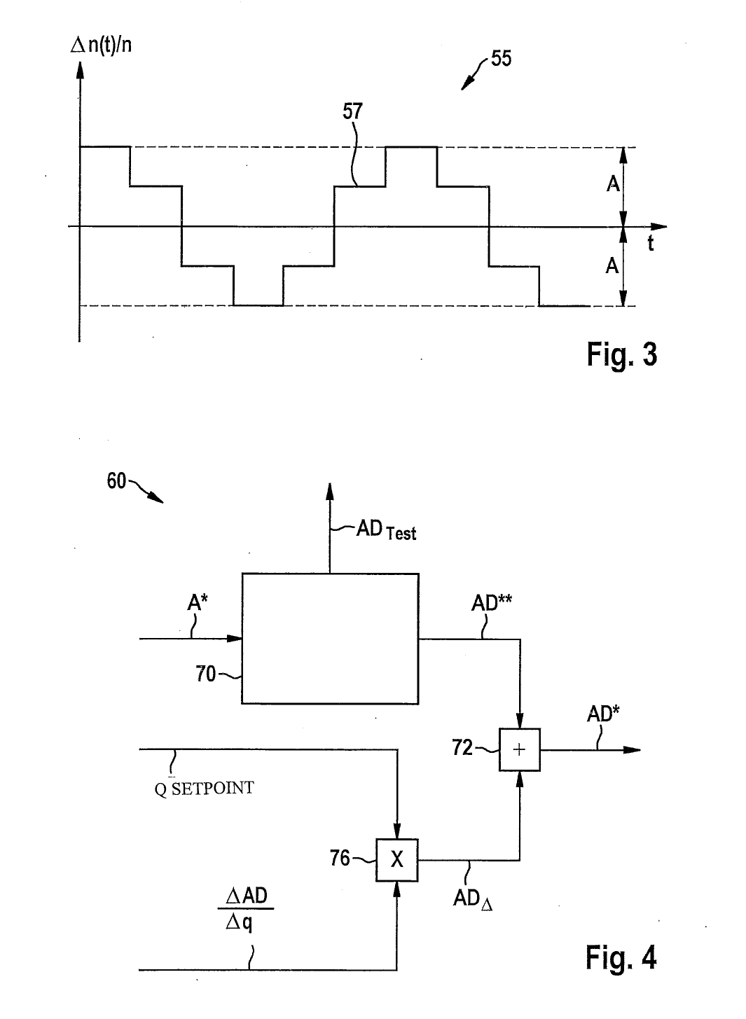

Block 64 generates a rotational speed change rate Δn(t)/n which normalizes rotational speed signal n(t) to an averaged rotational speed n. Averaged rotational speed n is ascertained from rotational speed signal n(t) with the aid of a mean value operation, for example. Alternatively to rotational speed change rate Δn(t)/n, another segment time signal may accordingly also be used. The effect of injection quantity q is reflected, among other things, in rotational speed change rate Δn(t)/n. A raw amplitude A, which is assigned to injection quantity q and test control period ADtest, may accordingly be ascertained from rotational speed change rate Δn(t)/n with the aid of a block 66. The ascertainment of raw amplitude A is explained in greater detail with reference to FIG. 3.

In a linkage 68, raw amplitude A is multiplied by a factor k, the product of this multiplication being a compensated amplitude A*. Factor k corresponds to the square of averaged rotational speed n, for example. Amplitude A* is supplied to block 60. Furthermore, a setpoint injection quantity qsetpoint is supplied to block 60. Block 60 ascertains from setpoint injection quantity qsetpoint, among other things, an operating point-dependent control period AD*, which is ascertained as a function of an operating point of internal combustion engine 12, i.e., for example, as a function of the driver input, and essentially compensates for the service life drift of injection 30. Setpoint injection quantity qsetpoint may, for example, be ascertained from a setpoint value for compensated amplitude A* or from raw amplitude A. Alternatively to compensated amplitude A*, raw amplitude A may also be supplied to block 60.

FIG. 3 shows a schematic diagram 55 of a time and rotational speed change rate, rotational speed change rate Δn(t)/n being plotted against time t. Curve 57 is illustrated to be free of mean values and shows a rotational speed oscillation. The rotational speed oscillation has raw amplitude A. Raw amplitude A results from control period AD or associated injection quantity q. As explained above, compensated amplitude A* is ascertained from the raw amplitude.

Compensated amplitude A* is referred to in the following as amplitude A*.

FIG. 4 shows a detailed schematic block diagram of block 60 for ascertaining operating point-dependent control period AD* of injector 30. A block 70 generates test control period ADtest. Amplitude A* is supplied to block 70. Block 70 ascertains a minimum control period AD** during which injector 30 does not open just yet or at which the injector is just still closed, or at which injector 30 is in a state between opening and closing or closing and opening. Minimum control period AD** is supplied to a linkage 72.

A gradient ΔAD/Δq is stored as a constant, for example, and is derived from an engine characteristic map of control durations and injection quantities which is specific to the injector type. Gradient ΔAD/Δq is determined here from an almost linear range of the aforementioned engine characteristic map, the almost linear range being in the range of the control period during which the injector reliably opens. Gradient ΔAD/Δq is ascertained from a control period section dAD and an associated fuel quantity section dq. In linkage 76, gradient ΔAD/Δq is multiplied by setpoint injection quantity qsetpoint, the product of this multiplication being a differential control period ADΔ.

In linkage 72, minimum control period AD** and differential control period ADΔ are additively linked to form operating point-dependent control period AD*. Operating point-dependent control period AD* is thus ascertained from an additive linkage of minimum control period AD** to a multiplicative linkage of setpoint injection quantity qsetpoint and gradient ΔAD/Δq.

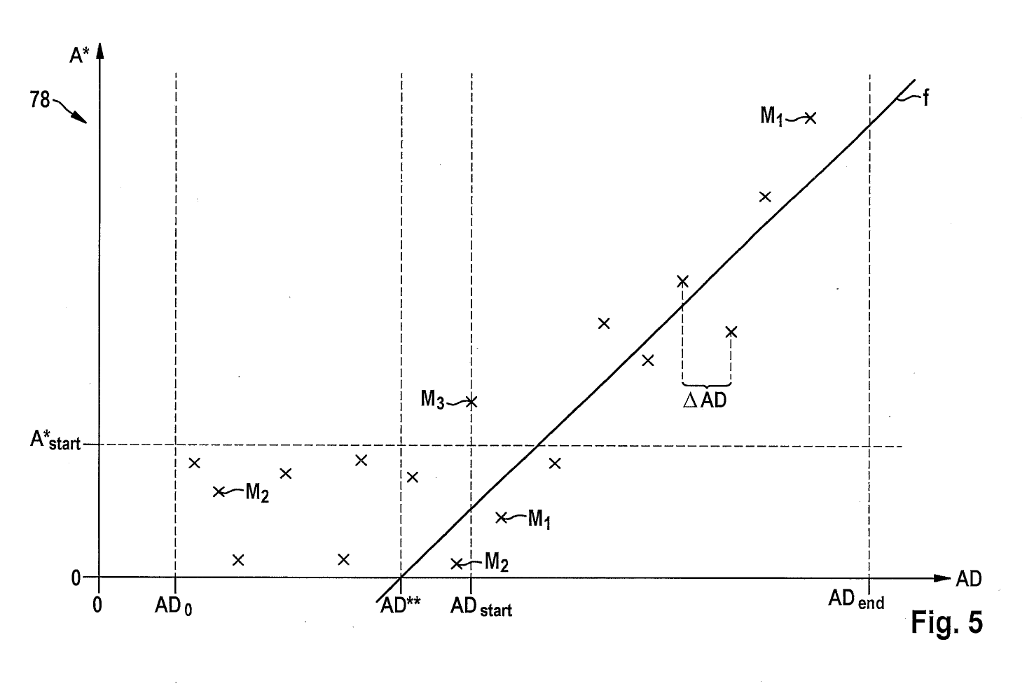

FIG. 5 shows a diagram 78 of control periods and amplitudes having an AD coordinate axis and an A* coordinate axis which intersect in their zero points. A minimum control period AD0, minimum control period AD**, a starting control period ADstart, and an ending control period ADend are plotted on the AD coordinate axis. A step width ΔAD denotes the distance between two value pairs M1 in relation to the AD coordinate axis. A starting amplitude Astart is plotted on the A* coordinate axis. Value pairs M1 are between starting control period ADstart and ending control period ADend. Value pairs M2 are between minimum control period AD0 and starting control period ADstart. One value pair M3 is located at starting control period ADstart. Each of value pairs M1, M2 or M3 includes control period AD and amplitude A* ascertained during control period AD. A function f is ascertained from a defined number of value pairs M1. Function f may be ascertained from value pairs M1 with the aid of linear regression. Minimum control period AD** is ascertained from function f in such a way that minimum control period AD** results for a value of amplitude A* being equal to zero.

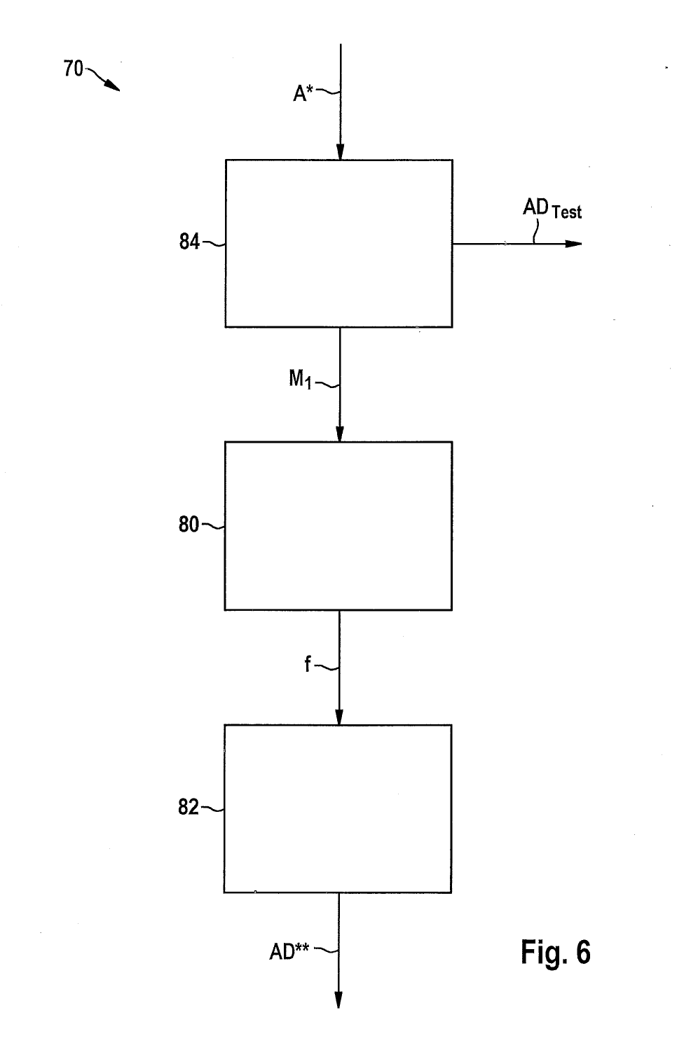

Below minimum control period AD**, injector 30 does not open, fuel is not metered into combustion chamber 16, and the variation of control period AD accordingly does not have an influence on amplitude A*. Above minimum control period AD**, injector 30 is opened, injection quantity q is metered into combustion chamber 16, and increasing control period AD has an increasing influence on amplitude A*. Injection quantity q is approximately proportional to the opening time of injector 30, the opening time of injector 30 approximately being difference AD-AD**. Amplitude A* or raw amplitude A is approximately proportional to the generated torque oscillation on the crankshaft and thus almost proportional to associated injection quantity q. For a control period AD which is longer than minimum control period AD**, there is thus an almost linear correlation between amplitude A* and control period AD. Other correlations in FIG. 5 are explained in greater detail in the following with reference to FIG. 6.

FIG. 6 shows a schematic block diagram of block 70 from FIG. 4 for ascertaining minimum control period AD**. A block 84 generates test control period ADtest. Amplitude A* associated with test control period ADtest is supplied to block 84. Block 84 generates multiple value pairs M1 which are supplied to a block 80. Block 80 generates function f from multiple value pairs M1. Function f is supplied to a block 82. Block 82 generates minimum control period AD**. Block 84 essentially executes two steps to ascertain multiple value pairs M1. In a first step, block 84 ascertains starting control period ADstart, step width ΔAD, and ending control period ADend which are used to ascertain multiple value pairs M1 in a second step.

In the first step, starting control period ADstart is initially ascertained, among other things. For this purpose, a starting amplitude A*start is ascertained from multiple values for amplitude A*, control period AD being increased, e.g., starting form a minimum control period AD0. Amplitude A* exceeds starting amplitude A*start during starting control period ADstart. The exceedance of starting amplitude A*start means that the effects of test control periods ADtest are reliably measurable via starting control period ADstart. Starting control period ADstart is thus characterized in that injector 30 opens to the extent that a rotational speed oscillation is triggered which is differentiable from the background noise. According to amplitude A* of value pair M3, amplitude A* exceeds starting amplitude A*start and thereby establishes starting control period ADstart.

Starting amplitude A*start may be a multiple of the standard deviation of the ascertained multiple values for amplitude A*, for example. In particular, starting amplitude A*start is a quadruple of the standard deviation of the multiple values of amplitude A*. The multiple values for amplitude A* correspond, together with control period AD, to value pairs M2 of FIG. 5. To ascertain the multiple values of amplitude A*, injector 30 is controlled in the coasting mode of the internal combustion engine for such a short test control period ADtest that injector 30 reliably does not open. The multiple values of amplitude A* may also be ascertained in coasting mode without test control periods of injector 30. The multiple values for amplitude A* correspond to a background noise of internal combustion engine 12 if injector 30 does not open. The background noise, which is assigned to the drivetrain of the internal combustion engine, also includes a noise which may form due to the measurement and the ascertainment of amplitude A*, among other things.

In the first step, ending control period ADend is determined in such a way that the value range between starting control period ADstart and ending control period ADend is long enough to allow function f to be determined, and that ending control period ADend is short enough to prevent interfering noises of the internal combustion engine. Step width ΔAD is used to establish the distance between individual value pairs M1 or control periods AD of value pairs M1, so that value pairs M1 do not accumulate in a range of control period AD.

In the second step, block 84 now generates test control periods ADtest between starting control period ADstart and ending control period ADend and assigns an ascertained supplied amplitude A* to respective test control period ADtest, value pairs M1 being formed. A defined number of value pairs M1 is ascertained. Value pairs M1 are ascertained by block 84 in a first state of internal combustion engine 12, in the first state a transmission ratio of a power train of internal combustion engine 12 being established. A certain engaged gear corresponds to a fixed transmission ratio of the power train of the internal combustion engine. Value pairs M1 may also be ascertained in a second state of internal combustion engine 12, in the second state internal combustion engine 12 being operated in a certain range of the rotational speed. The first and the second states of internal combustion engine 12 may also take place together. Furthermore, other states and/or conditions are also possible which may determine the ascertainment of value pairs M1. The goal is to ascertain a series, i.e., a defined number of value pairs M1 in a gear or rotational speed range, whereby a straight line may be approximated. Multiple such series may be used to approximate a joint straight line.

Test control periods ADtest for ascertaining value pairs M1 may be changed incrementally by a step width ΔAD per step. Furthermore, test control periods ADtest for ascertaining value pairs M1 may be alternatingly increased and reduced by block 84 across the range between starting control period ADstart and ending control period ADend, it being additionally possible to use a different gear stage each time for such a sequence. The incremental change in or the alternating increase and reduction of test control period ADtest is suitable to achieve a uniform distribution of value pairs M1 with regard to the time and/or with regard to the rotational speed, and/or with regard to the range between staring control period ADstart and ending control period ADend.

Block 80 carries out the linear regression with the aid of at least two value pairs M1 to ascertain a straight line according to function f from the at least two value pairs M1. Function f thus forms the control behavior of one single type of injector 30. By updating or recalculating function f, a drift may be detected in the control behavior of injector 30 over its service life. The ascertainment of minimum control period AD** is ascertained in block 82 according to a point where function f and the AD coordinate axis intersect.

The above-described methods may be carried out as a computer program for a digital arithmetic unit. The digital arithmetic unit is suitable to carry out the above-described methods as a computer program. The internal combustion engine, in particular for a motor vehicle, includes a control unit which includes the digital arithmetic unit, in particular a microprocessor. The control unit includes a storage medium on which the computer program is stored.

1-16. (canceled)

17. A method for operating an internal combustion engine, which is of a motor vehicle, comprising:
opening an injector, which is for metering fuel into a combustion chamber, for metering a fuel quantity during a control period and a change in a rotary motion of the internal combustion engine, which results from the fuel quantity being ascertained; and
ascertaining a function which links the control period to the change in the rotary motion;
ascertaining a minimum control period, during which the injector does not open just yet, with the aid of the function; and
ascertaining an operating point-dependent control period of the injector as a function of the minimum control period.

18. The method of claim 17, wherein the change in the rotary motion of the internal combustion engine is ascertained with the aid of an amplitude of a rotational speed change rate.

19. The method of claim 18, wherein a raw amplitude is multiplicatively linked to the square of an averaged rotational speed of the internal combustion engine to form a compensated amplitude, and wherein the function links the control period to the compensated amplitude.

20. The method of claim 17, wherein the operating point-dependent control period is ascertained by an additive linkage of the minimum control period to a multiplicative linkage of a setpoint injection quantity and a gradient.

21. The method of claim 17, wherein multiple value pairs are ascertained, each of value pairs including the control period and the change in the rotary motion or the amplitude ascertained during the control period and the function being ascertained from the value pairs with the aid of linear regression.

22. The method of claim 17, wherein the minimum control period is ascertained from the function, so that according to the function the minimum control period results for a value of the change in the rotary motion or the amplitude being equal to zero.

23. The method of claim 21, wherein the control period of one of the value pairs is greater than a starting control period.

24. The method of claim 23, wherein a starting amplitude is ascertained from multiple values for the amplitude, the control period being increased, starting from a minimum control period, and the amplitude exceeding the starting amplitude during the starting control period.

25. The method of claim 24, wherein a standard deviation is ascertained from multiple values for the amplitude, and wherein the starting amplitude is ascertained as a multiple or quadruple of the standard deviation.

26. The method of claim 24, wherein the injector for ascertaining the multiple values of the amplitude is controlled for such a short test control period that the injector does not open as expected.

27. The method of claim 24, wherein the multiple values of the amplitude are ascertained in the coasting mode of the internal combustion engine.

28. The method of claim 21, wherein a defined number of value pairs for ascertaining the function is ascertained in a first state of the internal combustion engine, in the first state a transmission ratio of a power train of the internal combustion engine being established.

29. The method of claim 21, wherein the value pairs for ascertaining the function are ascertained in a second state of the internal combustion engine, and wherein in the second state the internal combustion engine is operated in a certain range of the rotational speed.

30. A computer readable medium having a computer program, which is executable by a processor and/or a digital arithmetic unit, comprising:
a program code arrangement having program code for operating an internal combustion engine, which is of a motor vehicle, by performing the following:
opening an injector, which is for metering fuel into a combustion chamber, for metering a fuel quantity during a control period and a change in a rotary motion of the internal combustion engine, which results from the fuel quantity being ascertained; and
ascertaining a function which links the control period to the change in the rotary motion;
ascertaining a minimum control period, during which the injector does not open just yet, with the aid of the function; and
ascertaining an operating point-dependent control period of the injector as a function of the minimum control period.

31. A control unit for an internal combustion engine, which is for a motor vehicle, which is provided with a digital arithmetic unit and/or a microprocessor, comprising:
a control arrangement which is configured for operating the internal combustion engine by performing the following:
opening an injector, which is for metering fuel into a combustion chamber, for metering a fuel quantity during a control period and a change in a rotary motion of the internal combustion engine, which results from the fuel quantity being ascertained; and
ascertaining a function which links the control period to the change in the rotary motion;
ascertaining a minimum control period, during which the injector does not open just yet, with the aid of the function; and
ascertaining an operating point-dependent control period of the injector as a function of the minimum control period.

32. The control unit of claim 31, wherein the change in the rotary motion of the internal combustion engine is ascertained with the aid of an amplitude of a rotational speed change rate.

33. The control unit of claim 32, wherein a raw amplitude is multiplicatively linked to the square of an averaged rotational speed of the internal combustion engine to form a compensated amplitude, and wherein the function links the control period to the compensated amplitude.

34. The control unit of claim 31, wherein the operating point-dependent control period is ascertained by an additive linkage of the minimum control period to a multiplicative linkage of a setpoint injection quantity and a gradient.

35. The control unit of claim 31, wherein multiple value pairs are ascertained, each of value pairs including the control period and the change in the rotary motion or the amplitude ascertained during the control period and the function being ascertained from the value pairs with the aid of linear regression.

36. The control unit of claim 31, wherein the minimum control period is ascertained from the function, so that according to the function the minimum control period results for a value of the change in the rotary motion or the amplitude being equal to zero.
